(19) United States
(12) Patent Application Publication
(10) Pub. No.: US 2002/0163173 A1
(43) Pub. Date: Nov. 7, 2002

(54) Contoured hip/straight member vehicle frame

(76) Inventors: Phillip C. Ruehl, Elm Grove, WI (US); Gian Luigi Perello, Strambino (IT)

Correspondence Address: Oppenheimer Wolff & Donnelly LLP, 45 South Seventh Street, Suite 3300, Minneapolis, MN, 55402-1609, US

(21) Appl. No.: 09/850,569

(22) Filed: May 7, 2001

(51) Int. Cl. B62D 21/00; B62D 24/00

(52) U.S. Cl. 280/781; 180/311

(57) ABSTRACT

A versatile vehicle frame and method of making which includes a plurality of substantially straight, horizontal members connected with connecting hips having complex geometries. All contours and curves are incorporated into these hips, thus allowing the remainder of the frame to utilize substantially straight members. The vehicle frame permits a variety of frame lengths and widths by providing a variety of straight members having differing lengths. This versatility results in significantly reduced manufacturing costs and model flexibility mid-program.

### BACKGROUND OF THE INVENTION

The present invention pertains generally to vehicle frame designs, preferably for light trucks, sport utility vehicles (hereinafter “SUVs”), passenger vans, and/or some cars. More specifically, the present invention relates to a frame which utilizes a limited number of common curved or contoured members, thus making it economically feasible to produce low-volume niche vehicles.

There are basically two methods of building vehicles-unibody construction or body-on-frame (hereinafter “BOF”) construction. A “unibody chassis” is usually a plurality of members configured to generally form the shape of the vehicle when assembled. The members have complex geometries and are connected in many ways, such as welding, riveting, etc. Unibody chassis are usually used for cars and smaller vehicles. The unibody serves as both the body structure and the platform for mounting the suspension, drive train, steering, etc. BOF construction typically includes a sturdy, generally horizontal frame onto which the body is attached using isolated mounts. Also mounted to the frame are those systems, previously mentioned, for suspension, drive train, steering, etc. In either case, the body structure can be a “space-frame” to which the outer skin panels are attached without providing significant structural contribution.

The present invention pertains to BOF frame construction. Hereinafter, the term “frame” will be used to signify the typical base frame used in BOF construction.

Known vehicle frames, such as light truck frames, typically include a front frame portion for supporting the engine, steering, front suspension, bumper, front sheet metal, and part of the front cab. The frame further includes a rear frame portion for supporting the rest of the cab and/or the rear load box, and the rear suspension, bumper, drive train, etc. The side-rails of the frames are often made up of multiple sections and are connected at various joints. Various attempts have been made in the prior art to reduce the weight and cost of the frame, and typically involve reducing the gauge of the frame material and adding reinforcement or section depth for strength and/or stiffness where needed. This may require additional parts and/or more complex geometries. In some circumstances, these added parts create excessive cost which cannot be justified.

One approach to providing cost-effective frames for trucks and automobiles is described by U.S. Pat. No. 5,308,115 entitled “Vehicle Frame With Overlapped Sections,” which is incorporated herein by reference. The teachings of U.S. Pat. No. 5,308,115, and its parent, U.S. Pat. No. 5,149,132, pertain to improving truck frames by replacing the long (typically three to five meters) center/rear side-rails of conventional truck frames with two or three structural components which are formed separately and joined together at a designated location and orientation. In one embodiment, prior 3.75 m center/rear side-rails are each replaced by two 2 m side-rails overlapped by about 0.25 m.

Substituting a sectioned side-rail for a unitary side-rail provides significant reductions in manufacturing costs and material costs. Smaller components result in less scrap material because the kick-ups can be nested cross-coil and they are more easily shaped and transferred. More specifically, smaller components enable smaller, less expensive tooling, shorter tooling lead time, and smaller, more common, and less expensive presses for forming the sheet material. Often such presses can be found or located close to the vehicle assembly site. Using smaller presses is particularly advantageous because it facilitates faster cycle times, i.e. a smaller press ram often moves faster than a larger press ram. A faster cycle time is desirable because it may obviate the need for duplicate presses.

Additionally, the approach shown in U.S. Pat. No. 5,308,115 illustrates that certain sections or areas of the frame need to be strengthened much more than others. To meet this need, sections are overlapped to provide double stock thickness at highly stressed areas, such as rear spring front hangers of the typical light truck leaf spring rear suspension. Also, this enables minimum required gauge side-rail material to be provided fore and aft thereof.

With the increase in safety awareness, the strengthening of areas joining the front side member portion to the central portion, and the central portion to the rear portion, has become crucial. Safety considerations have encouraged the front and rear portions to be increasingly straight and boxed to better absorb crash energy. The joining sections, sometimes called “torque box” or “hip” areas, are often angled or offset in plan view and/or side view for functional reasons. This offset makes them vulnerable to collapse in a barrier crash. This is undesirable as they enclose the central passenger area of the body. Design and placement of the connecting cross members, joints, and angled portions must maximize the regions of the front and rear side-rails which are able to collapse like an accordion, but help the frame resist penetration into the passenger area. Thus, the angled portions or “hips” must be stiffer and stronger than the rest of the rails in order to protect the passengers.

As in many industries, continuous efforts are made to reduce the cost of all components or assemblies. While making significant improvements, the three-piece side-rails mentioned above have fairly complex geometries including various bent and angled portions. These geometries are necessary due to balance considerations and the functions of the various sections of the vehicle. Naturally, the more complex a particular part is, the more expensive it is to manufacture. Thus, one way to reduce the cost of the frame is to simplify the design of the various components. Even where the relatively complex geometries are isolated to small sections of a part, the entire component must be carried through the multiple operations needed to complete the complex area—necessarily requiring the use of large, expensive presses.

With many vehicles, different versions or sizes will require slight modifications to the frame components. For example, a pick-up truck (hereinafter “P/U”) may be sold in short-box and long-box, two wheel drive and four wheel drive versions. Also, a pick-up line may include regular cab, extended cab, and crew cab models and the range of rear axle ratings are often 3 or 4:1 between models (Class 1 to Class 5). To accommodate these models or versions, different frame constructions are required for each (albeit very similar designs). Various schemes have been applied over time to minimize the cost of unit and tooling requirements needed to accommodate these variations within a vehicle family. Today, in North America, most P/U families use the concept taught in the aforementioned Patents U.S. Pat. Nos. 5,149,132 and 5,308,115. In like manner, SUV's (often derived from P/U's) will require a wider frame to maximize passenger space. Similarly, passenger vans seek width, coupled with a short front overhang resulting in maximized passenger space relative to overall vehicle size. While passenger vans may share engine drivetrain and/or suspension components with comparable GVW P/U's and/or SUV's, they rarely share frame components. These different frame designs are required due to the complex geometries of each, requiring specific contours and complimentary joints.

As previously mentioned, the front portion of the frame supports the engine, steering, suspension, bumper and front sheet metal. The front portion of the frame must be designed such that it does not interfere with the front wheels, links or front axle. Therefore, the front portion of the frame has a relatively high elevation. The side-rails are also relatively close together in the front portion to allow the wheels to turn and to allow for suspension travel.

Conversely, the central portion of the frame must be low enough to allow passengers to enter and exit the cabin of the vehicle. If the central portion of the frame were at the same elevation as the front portion, the cabin would sit so high on the vehicle that unnecessary wind resistance would result, and the aesthetics of the vehicle would be greatly diminished. Providing low rails in the central section further lowers the center of gravity of the vehicle. The side-rails are also spaced apart to allow them to provide some side impact protection to the passenger area.

The rear portion of the frame needs to be high enough to clear the rear axle and the rails have to be narrowly set to provide wheel clearance and room for suspension travel. In the case of a truck, the elevation of the rear portion of the frame when the truck is fully loaded is also a consideration.

In order to meet these various positional/orientational needs, the side-rails are formed to have complex geometries. Specifically, the side-rails must include many contours and bends which allow appropriate positioning of the various rail portions. Also, due to these complex geometries, a given side-rail, or component thereof, has a shape unique to a given vehicle or family of vehicles and often cannot be used for larger or smaller vehicles. These complex geometries also preclude the use of pieces of straight stock cut to a predetermined length without subsequent shaping and working processes.

Many medium and heavy trucks avoid the complexities associated with these contoured side-rails by having high and narrow straight rails which extend the length of the vehicle. These trucks have longer wheel bases and wider track which makes a low center of gravity less critical. They also have enough mass to protect the passengers and usually have steps leading up to the passenger area. Moreover, large trucks and buses are produced in smaller quantities so the added expense of forming contours in the side-rails is not justified.

It would be advantageous to provide a frame design which efficiently allows for variations in size without requiring retooling or significant design modifications.

It would further be advantageous to provide a frame design which maximizes the use of straight stock. If straight stock is used, the length can easily be adjusted, thus providing great design flexibility.

It would also be advantageous to provide a frame in which the complex geometries and reinforced stress points are confined to relatively small, predetermined areas, so that the higher cost, multiple forming operations are limited to a much smaller portion of the overall frame.

Finally, it would be advantageous to be able to quickly convert manufacture from one vehicle to another depending on the dictates of the marketplace, rather than to establish a set volume capacity for a given vehicle and to be unable to efficiently change over the typical six to eight year model life.

### SUMMARY OF THE INVENTION

The present invention, therefore, relates to a vehicle frame which combines the advantages of straight stock components and a limited number of contoured joints or “nodes”. In the resulting frame, a majority of the curves and contours are limited to these hip nodes, thus minimizing the number of complex components. More specifically, the frame has contoured hip members which are constructed and arranged to be located at high load points on the frame, such as at the plan-view/side-view offsets and at the mount for the rear spring front hangers. The hips are stamped from relatively small blanks of a predetermined thickness, preferably greater than that of the other frame members. The hips or hip nodes are further designed so that substantially all of the complex geometries of the frame are provided by the hips, thereby maximizing the use of straight members for the remainder of the major frame members.

More specifically, the present invention provides a vehicle frame capable of supporting an engine and a vehicle body. The frame comprises four hips arranged roughly in a rectangle. Thus, there are two transversally opposed, forward hips and two transversally opposed, rear hips which are rearwardly displaced from the forward hips.

The two forward hips are attached to their opposed rear hip counterparts by two substantially straight, substantially horizontal central rails. The central rails are preferably cut from stock and attached to the hips using conventional methods. More preferably, the hips have integral rail receiving hoods which are configured to mate with the central rail stock such that the interior surface of the hood roughly matches the external geometry of the rail. This arrangement maximizes stability and provides sufficient surface to surface contact to create strong welds or mechanical connections. Cross members connect the two forward hips and the two rear hips in a similar fashion. The roughly rectangular assembly of the central rails and the cross members, joined by the hips, form the central portion of the frame.

The front portion of the frame is similarly formed by extending substantially straight and horizontal front rails from each of the forward hips. As discussed above, the front rails are often vertically displaced above the central side-rails so there is ample room for axle travel and wheel movement. Again, receiving hoods formed in the forward hips are configured to mate with the front rails.

Similarly, the rear portion of the frame is formed by extending substantially straight and horizontal rear rails from each of the rear hips. The rear rails may be vertically displaced from the central rails as necessary to ensure there is no interference with the rear axle. Receiving hoods are formed in the rear hips which are configured to mate with the rear rails.

The frame of the present invention can alternatively be described as having two five-piece side-rails connected together by cross members. The side-rails comprise a relatively straight, horizontal front rail, a contoured hip, a relatively straight, horizontal central rail, another contoured hip, and a relatively straight, horizontal rear rail. The hips have receiving hoods for joining the rails and receiving hoods for joining the cross members. These hips may be open sections, or, more preferably, boxed assemblies or hollow castings or even complex hydroform joints.

Alternatively, in another embodiment, the rail and/or crossmember sections might glove the outside of the contoured hip nodes. In some conditions this would create the advantageous situation of welding light gauge into heavy gauge which can be beneficial in extending fatigue life.

Some frame designs may benefit by adding additional cross members spanning the forward extremes of the front rails and across the rear extremes of the rear rails. These additional cross members complete the forward and rear portions and may also form the front and rear bumper reinforcements of the vehicle.

The substantially straight rails and members, by virtue of their very simple linear shape, will represent the lowest cost stock available for the material and manufacturing process selected. Some of the manufacturing processes and materials which may produce acceptable members and rails include stampings, roll forms, weldments, press breaks, tubes, rotary formed stock, extrusions of steel, iron or aluminum, filament wound fiber-reinforced plastic, and pultrusions.

It can thus be seen that this preferred design for a frame would allow longer or shorter straight rail sections to be used to create a longer or shorter frame front, center or rear. If a wider or narrower frame is desired, the lengths of the cross members may be adjusted accordingly. The complex geometries are contained within the hip pieces which are manufactured separately and can be used for a wide variety of different frames. As the hips are the most expensive pieces to manufacture, significant cost savings are provided by standardizing these pieces for a variety of different frames, and/or by minimizing their size.

It is thus an object of the invention to provide a frame design which allows for variations in size without requiring retooling or significant design modifications.

It is also an object of the invention to provide a frame design which maximizes the use of straight stock.

It is further an object of the invention to provide a frame in which the complex geometries are confined to relatively small, predetermined areas. Further, these relatively small areas are easily capable of providing reinforced stress points.

It is an additional object of the invention to provide a method for designing and building a frame which achieves these structural objects. Through maximization of straight stock and confining complex geometries to a limited portion of the frame, many design options and alternatives are available.

It is a further object of the present invention to provide a frame design which can easily accommodate model variations. Specifically, the frame can easily be lengthened or shortened to accommodate different models of vehicles.

It is an object of the invention to provide a frame for a very diverse “family” of low-volume niche vehicles of disparate vocation which would otherwise be severely penalized with costs for having a unique structural chassis. The same benefits of the present invention might ultimately have equal payoff for high-volume products.

These and further objects and advantages of the present invention will become clearer in light of the following detailed description of illustrative preferred embodiments of this invention described in connection with the drawings.

### BRIEF DESCRIPTION OF THE DRAWINGS

The illustrative embodiments may best be described by reference to the accompanying drawings where:

FIG. 1 is a plan view of a basic frame constructed in accordance with the present invention;

FIG. 2 is a side elevation of the frame of FIG. 1;

FIG. 3 is a perspective view of an alternate frame design constructed in accordance with the present invention;

FIG. 4 is a perspective view of a hip of the present invention;

FIG. 5 is a side elevation view of the hip of FIG. 4;

FIG. 6 is a front elevation view of the hip of FIG. 4;

FIG. 7 is a perspective view of an alternative hip of the present invention;

FIG. 8 is a side elevation view of the hip of FIG. 7;

FIG. 9 is a front elevation view of the hip of FIG. 7;

FIG. 10 is a perspective view of another alternative hip of the present invention;

FIG. 11 is a side elevation view of the hip of FIG. 10;

FIG. 12 is a front elevation view of the hip of FIG. 10;

All Figures are drawn for ease of explanation of the basic teachings of the preferred embodiments only. The extensions of the Figures with respect to number, position, relationship, and dimensions of the parts to form the preferred embodiments will be explained or will be within the skill of the art after the following description has been read and understood. Further, the exact dimensional proportions to conform to the specific force, weight, strength, and similar requirements will likewise be within the skill of the art after the following description has been read and understood.

Where used in the various figures of the drawings, the same numerals designate the same or similar parts. Furthermore, when the terms “top,” “bottom,” “upper,” “lower,” “first,” “second,” “front,” “rear,” “end,” “edge,” “forward,” “rearward,” “upward,” “downward,” “inward,” “outward,” “inside,” “side,” “longitudinal,” “lateral,” “horizontal,” “vertical,” and similar terms are used herein, it should be understood that these terms have reference only to the structure shown in the drawings as it would appear to a person viewing the drawings and are utilized only to facilitate describing the preferred embodiments.

### DETAILED DESCRIPTION OF THE PREFERRED EMBODIMENTS

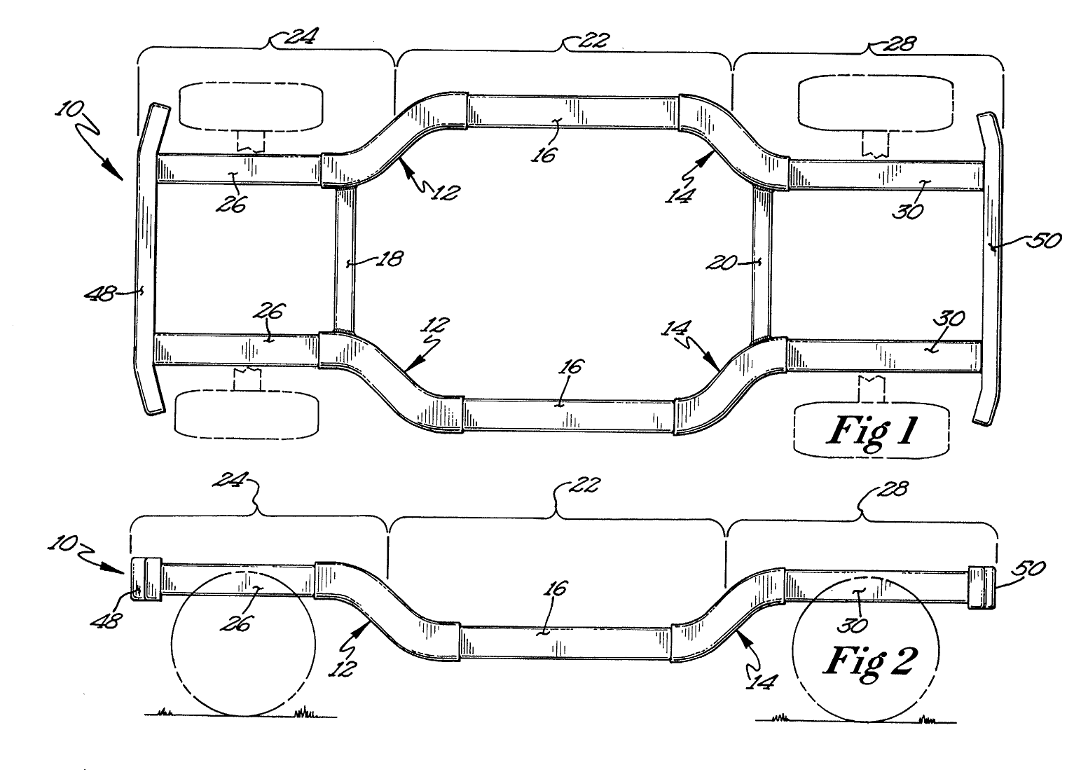

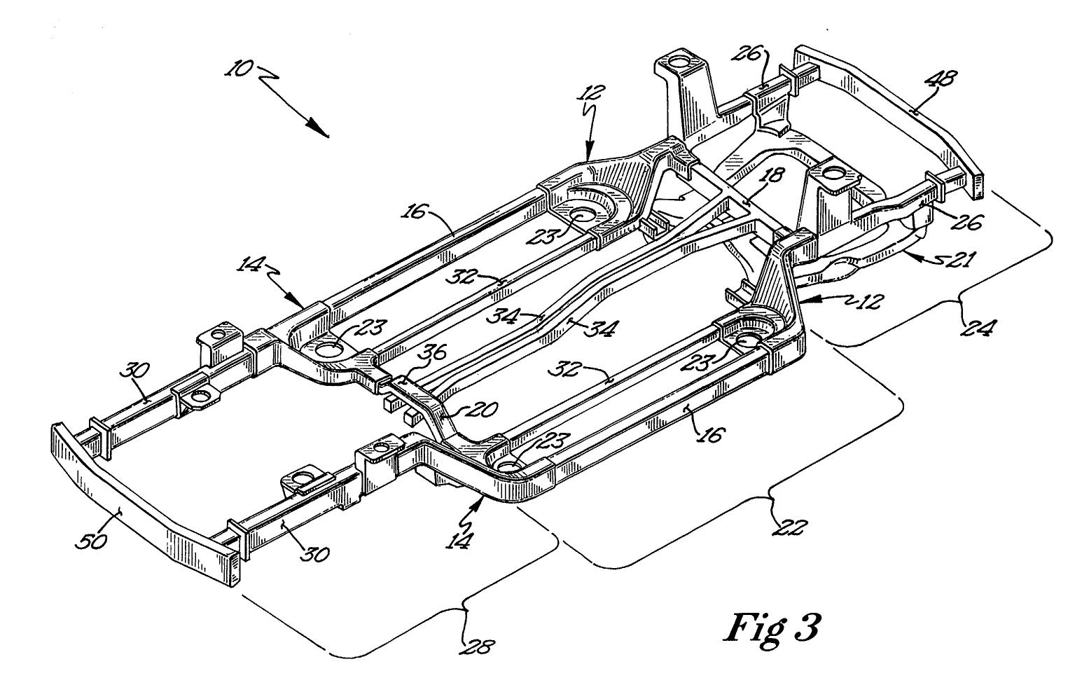

Referring now to the Figures, and first to FIGS. 1-3, there are shown two embodiments of a frame 10 comprising two forward hips 12 and two rear hips 14. The hips are connected by central rails 16, forward cross member 18 and rear cross member 20. The rails 16 and members 18 and 20 may be any shape, preferably boxed or C-sectioned. The embodiment shown in FIG. 3 further includes hip reinforcing rails 32 and tunnel reinforcing members 34, explained in more detail below.

The general rectangular assembly formed by forward hips 12, rear hips 14, central rails 16, forward cross member 18 and rear cross member 20, generally defines a frame central portion 22.

A frame front portion 24 is defined by front rails 26 extending forwardly from forward hips 12. Front rails 26 are substantially horizontal and elevated relative to central rails 16 to accommodate an engine block, suspension, and auxiliary components. Front rails 26 lend themselves to the attachment of a standard engine cradle 21 using conventional or otherwise appropriate methods such as welding. A front member 48 may be included which spans across the forward extremes of front rails 26. Front member 48 adds rigidity to frame front portion 24 and may serve as a front bumper reinforcement for the vehicle.

Similarly, a frame rear portion 28 is defined by rear rails 30 extending rearwardly from rear hips 14. Rear rails 30 may be horizontal or formed or angled slightly and are elevated relative to central rails 16 to ensure they clear the rear axle of the vehicle on which the frame will be suspended. A rear member 50 may be included which spans across the rear extremes of rear rails 30. Rear member 50 adds rigidity to frame rear portion 28 and may serve as a rear bumper reinforcement for the vehicle.

Notably, all of the rails 16, 26, and 30 and cross members 18 and 20 are substantially straight and horizontal.

FIG. 3 depicts an embodiment that further includes hip reinforcing members 32, which are provided to give additional stiffness to the passenger cabin and to strengthen the ability of the hips 12, 14 to maintain proper orientation while front rails 26 or rear rails 30 are being crushed during an impact. Additionally, tunnel reinforcing members 34 are provided to prevent the center of the passenger area from collapsing or buckling during impact and/or for functional structure or mounting points. Depending on the design of the vehicle, it may be necessary to form a bridge 36 in the rear cross member 20 in order to provide clearance for the tunnel passage of drivetrain, exhaust, etc.

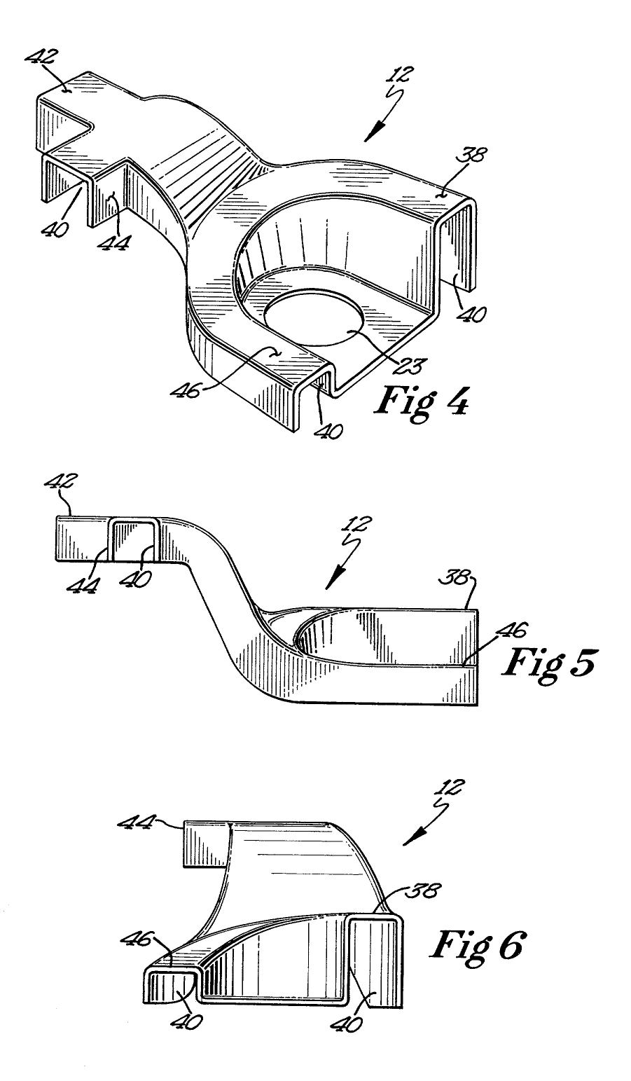

FIGS. 4-6 show a hip node 12 of the present invention. Forward hip nodes 12 and rear hip nodes 14 are similar enough in shape that a detailed description of hip node 12 is also applicable to hip nodel 14. Hip node 12 generally includes a plurality of receiving hoods, having inverted “U” shapes, constructed and arranged to mate with the various rails and cross members of a given frame design. More specifically, hip node 12 includes a first rail receiving hood 38 configured to mate with the central rail 16 in that it has an interior contour 40 which roughly matches the upper exterior surface of central rail 16. This arrangement provides lateral and transverse support and provides ample surface to surface contact for securing hip node 12 to central rail 16 through welding, bolting, adhesives, or the like.

A second rail receiving hood 42 is similarly constructed and arranged to mate with a front rail 26. FIG. 5 best shows the elevational difference between first rail receiving hood 38 and second rail receiving hood 42. FIG. 6 shows the transverse offset between first rail receiving hood 38 and second rail receiving hood 42. This allows for a desirably narrower frame front portion 24 than the frame central portion 22.

Preferably, left forward hip node 12 and right forward hip node 12 are mirror images of each other and rear hips 14 are structurally and geometrically identical to forward hips 12 to reduce manufacturing costs. Therefore, right rear hip nodel 14 is just a left forward hip node 12 rotated 180° around a vertical axis and left rear hip nodel 14 is just a right forward hip node 12 similarly rotated 180°. It can thus be seen that the second rail receiving hoods 42 on the rear hips 14 are configured to mate with rear rails 30 which are preferably cut from the same stock as front rails 26.

Alternatively, forward hips 12 may be structurally different from rear hips 14. This may be desired if it is anticipated that the load borne or clearance required by the rear hips 14 is significantly different from that borne or required by the forward hips 12. Moreover, the design of hips 12 and 14 may be altered to accommodate any number of rails or cross members. Additionally, the rear hips 14 might in some cases vary between vehicle types, such as a P/U and an SUV, if their relative lateral locations of the center rails 16 and the rear rails 30 were not identical.

Hips 12 also include a cross member receiving hood 44 configured to mate with forward cross member 18. Again, the cross member receiving hood 44 of hips 14 are configured to mate with the rear cross members 20 which are preferably cut from the same stock as forward cross members 18. Hip node 12 may include a body mounting feature 23. Such features can be integrated into the complex formings (stampings, castings, etc.) for further cost reduction.

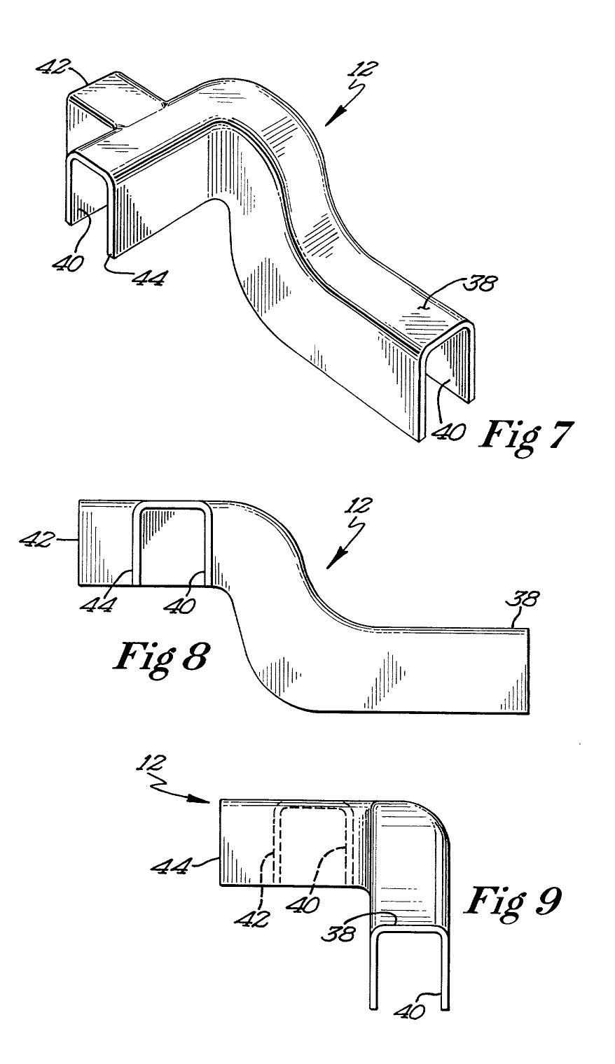

The embodiment of hip node 12 shown in FIGS. 4-6 further includes a receiving hood 46 for a hip reinforcing member 32. Hood 46 is shown as being smaller than the other hoods 38, 42, and 44. It is envisioned that a reinforcing member 32 that is smaller than the other rails of the present invention would be advantageous because the resulting frame would be lighter and because using a full sized rail may interfere with the foot room for the passengers in the cabin of the vehicle. An example of a similar embodiment of hip node 12, not having a receiving hood 46 for a hip reinforcing member 32, is shown in FIGS. 7-9.

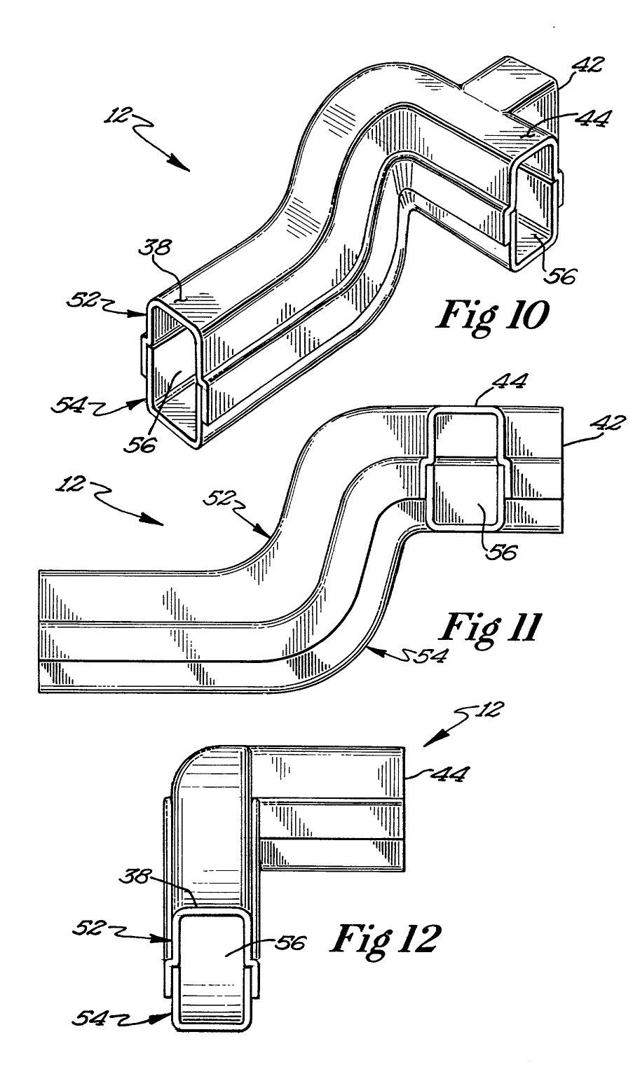

It is also envisioned to provide a hip node 12 comprising a boxed construction. FIGS. 10-12 show a hip node 12 having an upper half 52 and a lower half 54. Such a boxed construction adds significant strength and rigidity to hips 12, and thus to a frame 10. A straight member, such as side-rail 16, may be attached to hip 12 by inserting an end of the rail 16 into a boxed opening 56, defined by the upper half 52 and the lower half 54, or by providing a straight member sized to fit around the outside of the hip 12.

The described structural components of frame 10 facilitate the easy design of various sized frames simply by changing the lengths of the various rails and cross members. A preferred method of making the frame, therefore, begins with determining the desired overall length of the resulting vehicle and determining the necessary lengths of the front portion 24, the central portion 22 and the rear portion 28. The desired relative elevations and widths of each of the portions 22, 24, and 28 are also determined as well as the desired positions of the cross members 18 and 20. If it is desired to provide hip reinforcing members 32, a decision is made as to how the members 32 should be spaced from the central rails 16.

A hip node 12 is then designed having hoods 38, 42, 44, and 46 arranged to accommodate the desired positions of the rails and members received thereby. It is preferable to design hip node 12 so that it may be stamped. Alternatively, hip node 12 may be cast, forged or hydroformed.

Metal blanks of an appropriate size and shape are provided and stamped to form hips 12 and 14. Hips 12 and 14 are then arranged in a general rectangle pattern as shown in FIGS. 3 and 4. Rails 16, 26, and 30 and members 18, 20, and 32 are cut to length and secured within their respective receiving hoods 38, 42, 44, and 46.

Those skilled in the art will further appreciate that the present invention may be embodied in other specific forms without departing from the spirit or central attributes thereof. In that the foregoing description of the present invention discloses only exemplary embodiments thereof, it is to be understood that other variations are contemplated as being within the scope of the present invention. Accordingly, the present invention is not limited in the particular embodiments which have been described in detail therein. Rather, reference should be made to the appended claims as indicative of the scope and content of the present invention.

What is claimed is:

1. A vehicle frame capable of supporting an engine and a vehicle body, comprising:
two transversally opposed, forward hips;
two transversally opposed, rear hips, rearwardly displaced from said forward hips;
two substantially straight, substantially horizontal central rails connecting said forward hips to said rear hips;
a substantially straight, substantially horizontal front rail extending forwardly from each of said forward hips, said front rail vertically displaced from said central rails;
a substantially straight, substantially horizontal rear rail extending rearwardly from each of said rear hips, said rear rail vertically displaced from said central rails;
a forward cross member connecting said forward hips; and,
a rear cross member connecting said rear hips;
wherein each of said hips, said rails, and said cross members are formed separately.

2. The vehicle frame of claim 1 wherein said hips are stamped from blanks.

3. The vehicle frame of claim 1 wherein said hips lie in a common, horizontal plane.

4. The vehicle frame of claim 1 further comprising hip reinforcing members extending between forward hips and rear hips.

5. The vehicle frame of claim 1 further comprising a front member spanning forward extremes of said front rails.

6. The vehicle frame of claim 1 further comprising a rear member spanning rear extremes of said rear rails.

7. The vehicle frame of claim 1 wherein said central rails comprise boxed rails.

8. The vehicle frame of claim 1 wherein said central rails comprise C-section rails.

9. The vehicle frame of claim 1 wherein said front rails comprise boxed rails.

10. The vehicle frame of claim 1 wherein said front rails comprise C-section rails.

11. The vehicle frame of claim 1 wherein said rear rails comprise boxed rails.

12. The vehicle frame of claim 1 wherein said rear rails comprise C-section rails.

13. The vehicle frame of claim 1 wherein said front rail is laterally displaced from said central rails.

14. The vehicle frame of claim 1 wherein said rear rail is laterally displaced from said central rails.

15. A hip useable to connect a plurality of rails to form a vehicle frame comprising:
a first rail receiving hood configured to mate with a first rail such that said first rail extends horizontally from said first rail receiving hood; and,
a second rail receiving hood, connected to said first rail receiving hood, and configured to mate with a second rail such that said second rail extends horizontally from said second rail receiving hood and such that said second rail is transversally and vertically displaced from said first rail when said first rail and said second rail are mated with said hip.

16. The hip of claim 15 further comprising stamped metal.

17. The hip of claim 15 further comprising a reinforcing member receiving hood configured to mate with a hip reinforcing member.

18. The hip of claim 15 further comprising a cross member receiving hood configured to mate with a cross member such that said cross member is substantially perpendicular to and vertically displaced from at least one of said rails when said cross member and said at least one rail are mated with said hip.

19. The hip of claim 16 wherein said first and second rail receiving hoods are of unitary construction, formed from a single piece of stamped metal.

20. The hip of claim 16 wherein said first and second rail receiving hoods further comprise an upper stamping and a lower stamping, said upper stamping of unitary construction, formed from a single piece of stamped metal and defining a portion of both first and second rail receiving hoods, and said lower stamping of unitary construction, formed from a single piece of stamped metal and defining a remaining portion of both first and second rail receiving hoods, said upper and lower stampings operably connected to completely define said first and second rail receiving hoods.

21. The hip of claim 15 further comprising cast metal.

22. The hip of claim 15 further comprising forged metal.

23. The hip of claim 15 further comprising hydroformed metal.

24. A vehicle frame comprising a plurality of substantially straight, horizontal members having various relative elevations connected by four, separately formed, stamped metal hips.

25. The vehicle frame of claim 24 wherein said members comprise rails and cross members.

26. The vehicle frame of claim 25 wherein said hips comprise:
a first rail receiving hood configured to mate with a first rail such that said first rail extends horizontally from said first rail receiving hood; and,
a second rail receiving hood configured to mate with a second rail such that said second rail extends horizontally from said second rail receiving hood and such that said second rail is transversally and vertically displaced from said first rail when said first rail and said second rail are mated with said hip.

27. The vehicle frame of claim 26 wherein said hip further comprising a cross member receiving hood configured to mate with one of said cross members such that said cross member is substantially perpendicular to and vertically displaced from at least one of said rails when said cross member and said at least one rail are mated with said hip.

28. The vehicle frame of claim 26 wherein said rails and hips are joined to form two, substantially parallel, five piece side-rails, each of said side-rails comprising:
a front rail;
a central rail, aft of said front rail;
a hip joining said front rail and said central rail;
a rear rail; and,
a hip joining said central rail and said rear rail.

29. The vehicle frame of claim 28 wherein said two five-piece side-rails are joined together with said cross members, said cross members connected substantially perpendicularly to said side-rails by said hips.

30. The vehicle frame of claim 24 wherein said members comprise boxed rails.

31. The vehicle frame of 24 wherein said members comprise C-section rails.

32. A method of making a chassis for a vehicle comprising:
defining a front portion, a central portion, and a rear portion;
determining the necessary lengths of said portions based on the overall length and configuration of the vehicle;
determining the desired relative elevations of each of said portions;
determining the desired relative elevations of cross members which will transversally span the chassis between said front portion and said central portion, and between said central portion and said rear portion;
designing a hip shape capable of joining substantially straight rails having said desired relative elevations;
providing a plurality of metal blanks;
forming said blanks into hips having said hip shapes;
arranging said hips in a substantially rectangular pattern, such that said hips form the corners of said pattern, and each of said hips has a laterally spaced counterpart and a transversally spaced counterpart;
connecting said hips with their laterally spaced counterparts with straight central rails of a predetermined length;
connecting said hips with their transversally spaced counterparts with cross members of a predetermined length such that said hips, said central rails, and said cross members define said central portion;
extending two substantially straight, horizontal front members of a predetermined length from two of said transversally spaced hips, thereby partially defining said front portion;
extending two substantially straight, horizontal rear members of a predetermined length from the other two of said transversally spaced hips, thereby partially defining said rear portion.

33. The method of claim 32 wherein designing a hip shape further comprises designing a hip shape capable of joining hip reinforcing members.

34. The method of claim 33 further comprising connecting said hips with their laterally spaced counterparts using hip reinforcing members.

35. The method of claim 32 wherein designing a hip shape further comprises designing a hip shape having a plurality of receiving hoods configured to mate with said straight rails.

36. The method of claim 32 wherein designing a hip shape further comprises designing a hip shape having a receiving hood configured to mate with said cross member.

37. The method of claim 33 wherein designing a hip shape further comprises designing a hip shape having a receiving hood configured to mate with said reinforcing member.

38. The method of claim 35 wherein said receiving hoods comprise an inverted “U” shape.

39. The method of 32 further comprising determining the desired relative lateral locations of each of said portions.

40. The method of 39 wherein designing a hip shape comprises designing a hip shape capable of joining straight rails having said desired relative elevations and said lateral locations.

41. The method of claim 32 wherein forming said blanks into said hips comprises stamping said blanks into said hips.

42. The method of claim 32 wherein forming said blanks into said hips comprises forging said blanks into said hips.

43. The method of claim 32 wherein forming said blanks into said hips comprises casting said blanks into said hips.

44. The method of claim 32 wherein forming said blanks into said hips comprises hydroforming said blanks into said hips.

45. The method of claim 32 wherein providing four metal blanks comprises providing four metal upper blanks.

46. The method of claim 45 further comprising providing four metal lower blanks.

47. The method of claim 46 wherein forming said blanks into hips having said hip shapes comprises forming said upper blanks into hip upper halves and forming lower blanks into hip lower halves.

48. The method of claim 47 further comprising operably attaching said hip upper halves to hip lower halves, thereby constructing complete hips.

49. The method of claim 32 wherein designing a hip shape further comprises designing a hip shape including body mounting features.
